(19) United States
(12) Patent Application Publication
(10) Pub. No.: US 2004/0195830 A1
(43) Pub. Date: Oct. 7, 2004

(54) Injection molded coupling for fuel system components

(76) Inventor: Daniel A. Gilmour, West Hartford, CT (US)

Correspondence Address: REISING, ETHINGTON, BARNES, KISSELLE, P.C., P O BOX 4390, TROY, MI, 48099-4390, US

(21) Appl. No.: 10/404,994

(22) Filed: Apr. 1, 2003

(51) Int. Cl. F16L 33/00

(52) U.S. Cl. 285/239; 285/423

(57) ABSTRACT

A coupling for fuel system components including a female connector having an elongated tube portion that terminates in an opening for receiving a male connector. The opening has an inner diameter that is less than the outer diameter of the male connector such that the female connector stretches to accommodate the male connector and thereby form a seal. The female connector has a unitary structure formed by injection molding of a somewhat resilient plastic material.

### FIELD OF THE INVENTION

This invention relates to couplings for fuel system components and more particularly to connectors for fuel system components having a unitary structure produced by injection molding.

### BACKGROUND OF THE INVENTION

Couplings for fuel systems are known in the art and often are utilized to connect male and female connectors for fluid handling lines in a reliable manner. For example, quick coupling assemblies that include male and female connectors that are held together by friction locking members to permanently or releasably retain the male and female connectors are known in the art. One example of such a quick connect design utilizes a female connector or housing that receives one end of a male tube or line. A retainer is mounted in the female connector and includes a pair of deflectable fingers that snap behind a raised flange on a male connector or tube that has been inserted into the female connector. Various methods of retaining the male connector are known in the art, including utilizing fingers that snap into apertures formed in the female connector, such that depressing the fingers releasably retains the male connector within the female connector. The quick connect type of fuel couplings generally include an O-ring that abuts with the tubing to seal the tubing with the female connector. Also known in the art are clamps, commonly utilized to seal a male tubing or conduit within a female connector.

Connectors are often produced utilizing an extrusion process wherein a molten plastic is extruded through a die producing a hollow tubelike structure that may be cut to an appropriate size thereby producing a connector having two ends or ports. Such a structure is limiting in that both ends of an extruded tube are of the same size. There is, therefore, a need in the art for a connector for fuel system components that eliminates the need for the use of costly additional materials such as O-rings or clamps, as well as allows for unique or different end sizes on each end of a single female connector.

### SUMMARY OF THE INVENTION

A coupling for fuel system components that includes a female connector having at least one elongated tube portion that terminates in at least one opening for receiving a male connector. The opening has an inner diameter that is less than an outer diameter of the male connector, such that the female connector stretches to accommodate the male connector, thereby forming a seal. The female connector has a unitary structure that is formed by injection molding.

Objects, features and advantages of this invention include providing a coupling for fuel system components that does not include O-rings or clamps that are commonly currently utilized by couplings known in the art. The connector can have multiple ports with unique end sizes and smaller bend radii which cannot be produced utilizing an extrusion method. The connector for fuel system components of the present invention also reduces the number of parts necessary to form a seal, thereby reducing the overall cost of a connector for fuel system components and is of a relatively simple design, economical to manufacture and assemble, and in service has a long useful life.

### BRIEF DESCRIPTION OF THE DRAWINGS

These and other objects, features and advantages of the invention will be apparent from the following detailed description of the preferred embodiments and best mode, appended claims, and accompanying drawings in which:

FIG. 1 is a perspective view of a first embodiment of a connector having two ports;

FIG. 2 is a side view of the first embodiment shown in FIG. 1;

FIG. 3 is a perspective view of a second embodiment of a connector having three ports;

FIG. 4 is a side view of the second embodiment shown in FIG. 3;

FIG. 5 is a partial side view of a male connector having three barbs;

FIG. 6 is a partial side view of a male connector having two barbs;

FIG. 7 is a partial side view of a male connector having a single barb;

FIG. 8 is a fragmentary side view of an assembled female connector and male connector;

FIG. 9 is a perspective view of a retainer housing for a fuel regulator including multiple ports of various sizes; and

FIG. 10 is a perspective view of the retainer housing of FIG. 9 and of a retainer housing for a fuel filter to be connected thereto.

### DETAILED DESCRIPTION OF THE PREFERRED EMBODIMENTS

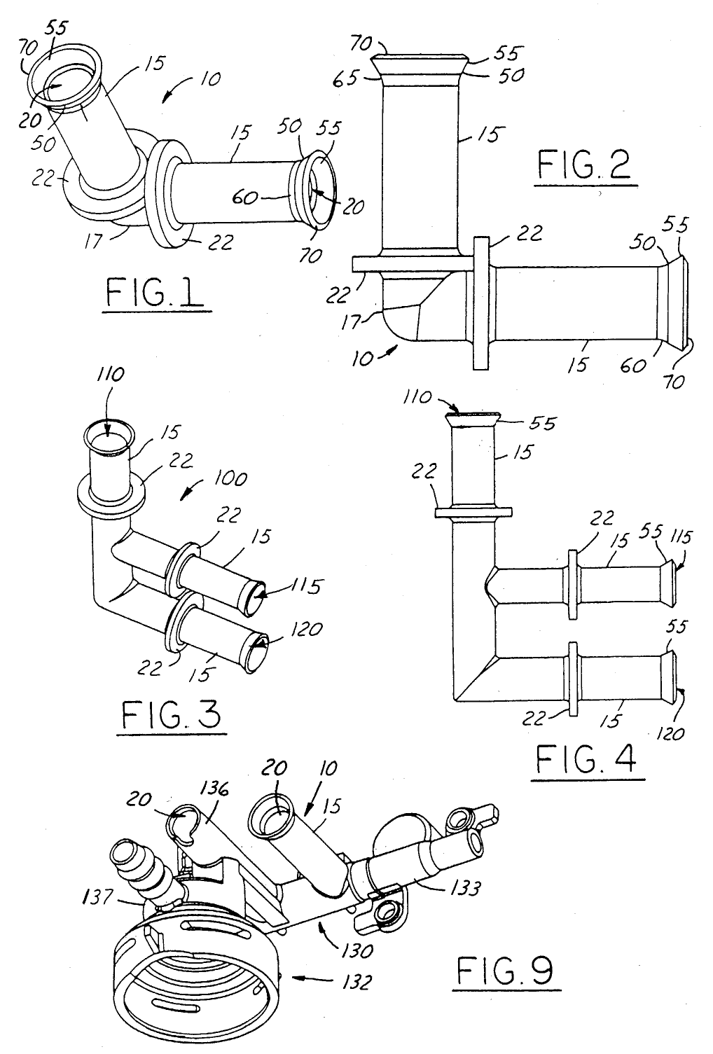

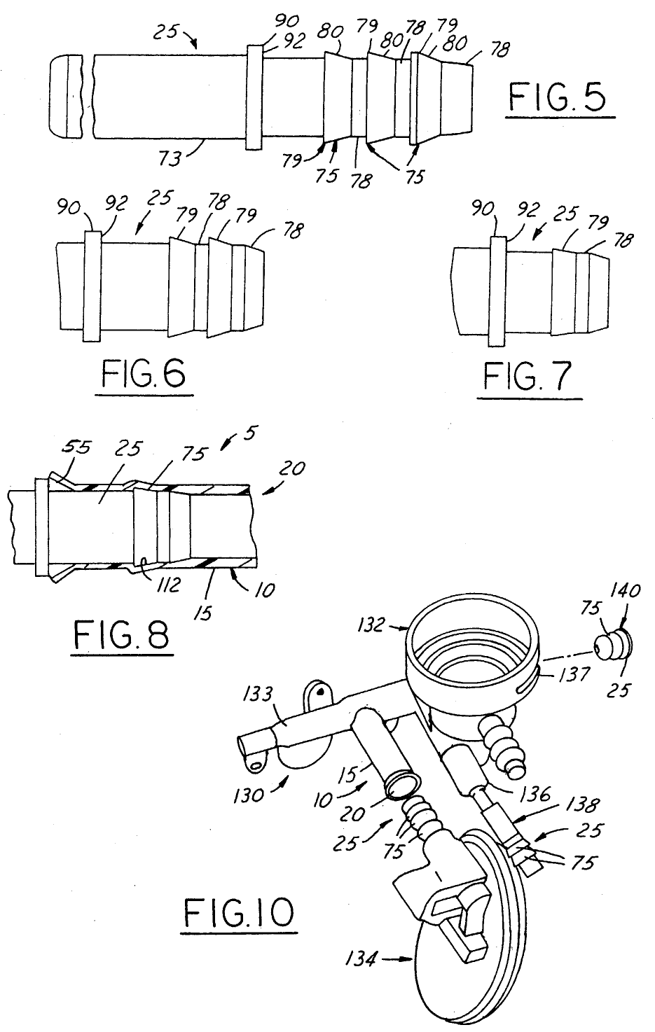

As shown in FIGS. 1 and 2, a first embodiment of a coupling 5 for fuel system components comprises a female connector 10 that has at least one elongated tube portion 15 that terminates in at least one opening 20 and receives a male connector 25 shown in FIGS. 5-7. Each opening 20 has an inner diameter that is less than an outer diameter of the male connector 25. As shown in FIG. 8, in assembly the female connector 10 resiliently stretches to accommodate the male connector 25, thereby providing a secure connection of and seal between the male 25 and female 10 connectors. The female connector 10 has a unitary structure that is formed by injection molding of a somewhat resilient plastic material.

The female connector 10 of the first embodiment includes two elongated tube portions 15 joined by a bend 17. The two elongated tube portions 15 terminate in two openings 20 at opposite ends of the elongated tube portions 15. As shown in FIGS. 1 and 2, the openings 20 have inner diameters of the same size. If desired, the openings 20 may have different inner diameters such that different sized male connectors 25 may be accepted by the female connector 10 to provide a secure connection. In this manner, the female connector 10 can accommodate various sized male connectors 25 that could not otherwise be accommodated by a female connector 10 produced by an extrusion method which requires similar sized openings 20 that would have to receive similar sized male connectors 25.

A shoulder 50 is formed proximate an end of the elongated tube portions 15 near each opening 20. Each shoulder 50 comprises a flared surface 55 for easy insertion of the male connector 25. The flared surface 55 has a diameter that increases radially from a first end 60 wherein the diameter is approximately equal to the inner diameter of the opening 20 and terminates at a second end 70 wherein the diameter is greater than the inner diameter of the opening 20. The flared surface 55 directs a male connector 25 towards the opening 20 and provides a guide prior to stretching the female connector 10 to form a seal connecting the female connector 10 and a male connector 25.

The female connector 10 also includes installation shoulders 22 formed integrally with the elongated tube portion 15 and spaced from the openings 20. The installation shoulders 22 generally comprise an annular flange projecting radially and extending circumferentially around the elongated tube portions 15 to provide a gripping region in which a person or machine installing the female connector 10 can grip the female connector 10 while the male connector 25 is inserted into the female connector 10. In this manner, reliable engagement of the female 10 and male 25 connectors is achieved to insure a seal.

FIGS. 3 and 4 illustrate another embodiment of a female connector 100 for fuel system components. The female connector 100 has a flared surface 55 at the end of each elongated tube portion 15, and installation shoulders 22, as previously described above. However, as can be seen in FIGS. 3 and 4, there are three openings 110, 115, 120 provided that each have a different inner diameter. The different diameters provide for various sized male connectors 25 to be inserted and may provide different flow characteristics for various portions of the female connector 100.

FIGS. 5-7 illustrate various forms of the male connector 25 of the coupling 5 of the present invention. As shown in FIG. 5, the male connector 25 has an elongated body 73 having at least one barb 75 and preferably three barbs 75 formed thereon. Each barb 75 has a circumferentially continuous peripheral surface 80 which is tapered or frustoconical and increases in diameter in a direction away from the end to be inserted into the female connector 10. At least the maximum diameter 79 of each barb 75 is greater than the inner diameter of the opening of the female connector 10 or 100 in which it is to be received. Each barb is axially spaced apart and preferably has an adjacent cylindrical portion 78 with an outside diameter preferably equal to the minimum diameter of the barbs 75 and preferably somewhat greater than the inner diameter of the associated opening of the associated female connector. The tapered portion 80 of the barbs 75 when inserted into the associated opening of the associated female connector stretches the female connector and forms a frictional press or interference fit to retain and seal the male and female connectors together. In this manner, the male connector 25 stretches the resilient female connector 10 or 100 such that the male connector is securely retained within the female connector, thereby providing a sealed coupling 5 for fuel system components. Also included in the male connector 25 is an integrally formed shoulder 90 projecting radially outward and extending circumferentially around the elongated portion 73 and spaced from the insertable end of the male connector 25. The shoulder 90 is spaced from the end of the male connector a distance corresponding to the axial extent the male connector is to be inserted into the female connector 10. When fully inserted, a surface 92 of the shoulder 90 bears on the free end of the flared surface 55 of the female connector 10 or 100, thereby limiting the depth of insertion of the male connector 25 into the female connector 10 or 100.

As shown in FIG. 8, in assembly and use, the female connector 10 receives the male connector 25 through the opening 20 of the female connector 10. The male connector 25 is inserted and moved into the female connector 10 thereby stretching the female connector 10 and frictionally engaging the barb(s) 75 formed on the male connector 25 to form a seal 112 defined by the interference fit of the barbs 75 of the male connector 25 with the inner surface of the elongated tube portion 15 of the female connector 10. The interference fit is capable of withstanding pressures without leaking associated with high pressure fuel systems which usually operate at a pressure in the range of from 40 to 80 psi, though this invention is not limited to this pressure range. The female connector 10 and male connector 25 when fully engaged form a seal without the use of additional sealing connectors such as O-rings and clamps commonly utilized in the art. As stated above, the female connector 10 is formed by an injection molding process and preferably comprises materials such as nylon 12, polyethylene, polypropylene, acetyl, or other fuel resistant plastic polymers. Preferably, the male connector is also injection molded of a suitable plastic material.

FIGS. 9 and 10 illustrate a manifold 130 having one or more components for couplings designed for use with a fuel pressure regulator system. The manifold includes an injection molded regulator retainer housing 132 that has an integral female connector 10 having an elongated tube portion 15 terminating in an opening 20 for received a male connector 25 integrally injection molded as part of a retainer housing 134 for a fuel filter (FIG. 10). The manifold 130 also preferably has a second female connector 136 formed integrally therewith. A tube 133 of the manifold 130 communicates with the connector 10 and the connector 136 and has an open female connector 137 at one end of the tube 133. Connector 136 is adapted to receive a valve guide 138 that includes a male connector 25 having barbs 75 as discussed above. Also, a plug 140 including a male connector 25 is inserted into the female connector 137 to close it. The manifold 130 and regulator housing 132 are preferably formed by an injection molding process, such that the female connectors 10, 136, 137 are of a unitary structure including the tube 133.

Through the use of the coupling 5 of the present invention, the fuel pressure regulator subassembly is easy to assemble and has eliminated the use of two O-rings that would commonly be utilized when connecting the filter and valve guide subassemblies to the regulator retainer housing. Also, the plug 140 that is inserted into the connector 137 of the manifold and regulator housing has been ultrasonically welded in the past to permanently attach the plug to the regulator housing. But through the use of the coupling 5 including male and female connectors, ultrasonic welding is not necessary to seal and/or retain the plug in the port 137 thereby eliminating a source of contamination (weld flash) of plastic particles within the pump subassembly.

While preferred embodiments are disclosed, a person of ordinary skill in this art would understand that various modifications will come within the spirit and scope of the invention, as defined by the following claims.

1. A coupling for fuel system components comprising:
a female connector having at least one elongated tube portion terminating in at least one opening for receiving a male connector, said at least one elongated tube having a substantially constant inner diameter in the area of said at least one opening that is less than an outer diameter of the male connector such that the female connector stretches in said area of substantially constant inner diameter to accommodate the male connector, the female connector having a resilient unitary structure formed by injection molding.

2. The coupling of claim 1 wherein the at least one opening comprises two openings at opposite ends of the elongated tube portion.

3. The coupling of claim 2 wherein the two openings have different diameters.

4. The coupling of claim 1 which also comprises a shoulder formed on the elongated tube portion proximate the opening.

5. The coupling of claim 4 wherein the shoulder comprises a flared surface for easing insertion of the male connector.

6. The coupling of claim 5 wherein the flared surface has a diameter that increases from a first end having a diameter approximately equal to the inner diameter of the elongated tube in the area wherein the male connector is received to a second end wherein the diameter is greater than said substantially constant inner diameter.

7. The coupling of claim 1 which also comprises a male connector having at least one barb formed thereon.

8. The coupling of claim 7 wherein the at least one barb comprises a circumferential continuous peripheral surface having a diameter that is greater than said substantially constant inner diameter.

9. The coupling of claim 1 wherein the female connector and male connector engage to form a seal via an interference fit capable of withstanding the pressure of a high pressure fuel system having a pressure in the range of from 40 to 80 psi.

10. The coupling of claim 1 wherein the female and male connectors engage to form a seal without the use of additional sealing components.

11. The coupling of claim 1 wherein the female and male connectors engage to form a seal without the use of O-rings and clamps.

12. The coupling of claim 1 wherein the female connector includes a plurality of elongated tube portions for engaging a plurality of male connectors.

13. The coupling of claim 10 wherein said at least one elongated tube includes a plurality of elongated tube portions that terminate at openings having different diameters.

14. A coupling comprising:
a female connector having at least one elongated tube portion terminating in at least three openings each adapted to receive a separate male connector, the openings being in fluid communication with each other, and each having an inner diameter less than an outer diameter of its respective male connector such that the female connector stretches to accommodate each of the male connectors, the female connector having a unitary structure formed by injection molding.

15. The coupling of claim 14 wherein said elongated tube includes a bend between at least two of said openings.

16. The coupling of claim 15 wherein said bend orients said at least two openings at a right angle from each other.

17. The coupling of claim 7 wherein said male connector includes a radially projecting flange adapted to engage the elongated tube in the area of an opening to limit insertion of the male connector in said opening.

18. A manifold for use with a fuel pressure regulator, comprising:
at least one elongated tube portion terminating in at least one opening adapted to receive a male connector, and having an inner diameter less than an outer diameter of the male connector such that the at least one elongated tube stretches to accommodate the male connector, and a housing integral with said at least one elongated tube portion adapted to communicate with a fuel pressure regulator to communicate the fuel pressure regulator with said at least one opening.

19. The manifold of claim 18 wherein said housing defines a portion of the housing of the fuel pressure regulator.

20. The manifold of claim 18 wherein two openings are provided with each opening adapted to receive a different male connector with the tube being stretched by each male connector.

21. A method of forming a coupling, comprising the steps of:
injection molding a female connector having at least one elongated tube portion terminating in at least two openings each adapted to receive a male connector, the openings having an inner diameter less than an outer diameter of their respective male connectors such that the female connector stretches to accommodate the male connectors.

22. The method of claim 21 wherein the female connector includes a plurality of tube portions, each unitarily formed by injection molding.

23. The method of claim 21 which also includes the step of forming a housing integrally with said at least one elongated tube portion, the housing adapted to communicate with a fuel pressure regulator.
